(19) United States
(12) Patent Application Publication
(10) Pub. No.: US 2014/0266047 A1
(43) Pub. Date: Sep. 18, 2014

(54) SYSTEM AND METHOD FOR REMOTE MONITORING OF CHARGING THE BATTERY OF AN ELECTRIC VEHICLE, CHARGER AND DEVICE FOR USE IN THE SYSTEM AND METHOD

(71) Applicant: ABB B.V., AX Rotterdam (NL)

(72) Inventors: Egbert Wouter Joghum Robers, LK Delft (NL); Crijn Bouman, XD Den Haag (NL); Ali Ugur, ZK Den Haag (NL); Evelinde Van Dorp, BH Rijswijk (NL); Robert Tyrell, BM Amsterdam (NL)

(21) Appl. No.: 14/350,924

(22) PCT Filed: Oct. 8, 2012
(86) PCT No.: PCT/NL2012/050698

§ 371 Date: Apr. 10, 2014

(30) Foreign Application Priority Data
Oct. 10, 2011 (NL) 2007560

(51) Int. Cl. B60L 11/18

(52) U.S. Cl. CPC B60L 11/1848
USPC 320/109; 320/137

(57) ABSTRACT

The present invention relates to a charger for charging the battery of an electric vehicle, comprising at least one port for exchanging electric power and/or data with a vehicle during a charge session, first data communication means, for saving information regarding the charge session to a data storage location, second data communication means, for communicating a reference for obtaining access to the data storage location comprising the information regarding said charge session to an external device.

The present invention relates to a system and method for remote monitoring charging the battery of an electric vehicle, charger and device for use in the system and method.

Electric vehicles are becoming widespread due to the improvement of the charging infrastructure. It has become possible to charge electric vehicle with a moderate battery capacity full in nearly 15 minutes. However, this time period is still relatively long compared with the time spent at a filling station while filling a combustion engine vehicle with fuel. Most vehicle drivers don't wait at the charging site during the charge session, but usually take a coffee break. To check if the charging has ended they have to return to the charging site to look on the screen of the charger. If the charging is not finished they have to wait at the site or go back to wherever they were, which may be found annoying. A potential solution would be to offer the information on status of charging and control of charging remotely through a web-based system. This is a potentially user friendly solution; however it may introduce a privacy problem: anybody could check or control the charging process remotely if this person has access to the web based solution.

The electric vehicles aforementioned may comprise road vehicles such as cars or motorcycles, vehicles for indoor use or use on sites, such as (fork lift) trucks, and even vehicles for transport on water, on railroad tracks or in the air.

It is a goal of the present invention to take away the need to stay at or near the charger during the entire charging process while offering a solution for the user of the charge station to exclusively access the data or control to this charger.

The invention thereto proposes a charger for charging the battery of an electric vehicle, comprising at least one port for exchanging electric power with a vehicle during a charge session, first data communication means, for saving information regarding the charge session to a data storage location, second data communication means, for communicating a reference for obtaining access to the data storage location comprising the information regarding said charge session to an external device.

By providing information regarding the charge session to an external device, a user who is charging his or her vehicle may make use of the external device for monitoring the progress of the charging. The external device, may for example be a mobile or a smart phone, a PDA or a computer, such as a portable or tablet computer, configured for receiving the reference and for processing the data on the storage location.

The charger may further comprise a start button, which may be a physical button or a button displayed on a touch screen for actually starting the charge session.

In an embodiment of the present invention, the reference is a (quasi) unique reference, generated for each charge session by the charger and for example displayed on a screen on or near the charger. This reference can then be scanned by an external device with a camera. The reference is then used by the external device to retrieve the saved information. Since the charger may in particular be configured to update the saved information frequently or even continuously during a charging session, the external device is enabled to show in real-time information such as the state of charge of the vehicle battery, state of health, the actual charge current and voltage, the remaining charge time, the power delivered to the vehicle, the estimated driving range.

The reference can for example be a QR (quick response) reference, a one or two dimensional bar-reference or a color-reference, and it is preferably a unique reference to the data storage location of said specific charge session, that may comprise for instance a hyperlink, in particular a deep-link. The charger may at least partly controllable via the first or second communication means, and it may comprise the data storage location as an integrated part.

A method for charge behaviour estimation described in the Dutch patent application by the same applicant NL2007081 may be applied in the invention for determining the required charge power, the remaining charge time and other vehicle battery data. Vehicle battery data may be obtained by sensor measurements in the charger and data communication of the charger with the electric vehicle. The obtained data is eventually delivered to the external device.

The present invention provides the advantage that vehicle drivers can follow the progress of the charging at a more comfortable place than at the charging site.

In an embodiment, the charger may be configured to receive control signals via the first or second data communication means. A user may then even remotely control the charging for example by stopping and starting the charging session. The vehicle driver can also enter how much time he has before he has to drive off again; upon changes entered the charge settings are optimised by the charger. In order to enable entering commands, a virtual control panel for stopping or starting the charging session may be displayed on the external device.

A possible feature for multiport chargers, i.e. chargers with more than one port for exchanging power and/or data with an electric vehicle is that a user can enter a relative priority for its charge session with respect to other vehicles at the charger. When the user plans to stay longer at the charger site for some reason, he can indicate a low priority, and may receive a reward, such as a lower energy price.

In an embodiment the charger with a plurality of ports may communicate a reference for each port charging an electric vehicle. Depending on the situation the references can be scanned by the same or different mobile devices. The same can be done for a plurality of chargers with each showing their own reference on the display, when they all scanned by the same mobile devices an access portal for each charger will be opened in the mobile devices.

This invention can also be useful for large fleet owners. A taxi company with a vehicle fleet can easily check without going through all charge sites, which vehicle is fully charged and ready for a trip.

The charger may interact with billing and payment applications which run at the computers of utilities or other energy providers. The payment for the charging can also be done by linking to online banking applications after charging is finished or stopped by the user. There are different scenarios possible for the payment of the charging, in the following this will be explained into more detail with aid of several non-limiting examples.

### Example 1

The vehicle driver sends a payment request via SMS text message and a payment is deducted on their phone bill.

### Example 2

It is also possible that the reference is displayed on the screen after the vehicle driver has paid for a charge. A vehicle driver pays with a contactless smartcard at the charger, whereupon the charger displays the reference on the screen. The reference is scanned with a mobile device whereupon the reference on the screen disappears or becomes invalid and the access portal represented by the reference is accessed. The charging can be started with the mobile device and after finishing of the charging the delivered power and the total costs are displayed on the screen.

### Example 3

When charging has ended the payment can be done locally at the charger with the mobile phone using NFC. The payment can be deducted from pre-paid account or charged to phone or bank account directly.

Remote monitoring and control of the devices are preferably done over a secured connection. The references can be used once, because after scanning of the reference it becomes invalid or disappears from the display.

In an embodiment the means for generating the reference can be implemented in software, hardware or a combination thereof. In a practical embodiment the reference is generated by an internal controller of the charger.

In an implementation the means for transferring the reference could be a screen, a LED array, an RFID, Bluetooth, Wi-Fi, Wimax, Zigbee or any other wireless communication device or a loudspeaker.

In yet another embodiment a server could be a controller in the charger but can also be remotely located from the charger for example it could be a PC, notebook, gaming console, another charger, an electric vehicle or any other device with an embedded controller.

In an embodiment the mobile device could be a mobile phone, a personal digital assistant, a notebook, a tablet PC or any other handheld device.

In an preferred embodiment the reference is in particular generated by the controller in the charger, which also functions as a data storage.

The invention further relates to a system for monitoring a charging process, comprising at least one charger as described above, and an external device, like a mobile or a smart phone, a PDA or a computer, such as a portable or tablet computer, configured for receiving and following the reference and for processing the data on the storage location. The reference communicated by the charger may then lead to a webpage at a server, said server, at least having access to said stored data, and configured to disclose said data when an external device follows the reference.

The server may further host a website that discloses the saved information upon following the reference.

In the system, an external device, like a mobile or a smart phone, a PDA or a computer, such as a portable or tablet computer, configured for receiving the reference and for processing the data on the storage location may be used.

The external device may further be configured for sending a control signal to the first or second communication port of the charger, and may be configured to display a progress of the charge session of a vehicle. The external device may further be configured to display an estimation of the remaining time of the charge session of a vehicle. It can be configured to send a control command to the charger, such as a desired amount of kilometres the vehicle needs to be able to surpass, a maximum payment amount, an available amount of time, or an abort command.

The generation of a reference can be on demand or automatically each time a new vehicle is connected to the charger.

When the charging has finished the vehicle driver can be notified with a message send from the charging system to the external device. This message can be a text message or an audio message. The same or a different reference can be scanned by another vehicle driver who wants to connect to the same charger outlet which is still occupied. The second vehicle driver can then be notified when the charged vehicle is disconnected or when the vehicle drives away from the charging park. In the last case a vehicle detection means is implemented in the charger.

The invention will now be explained into more detail with reference of the following non limiting figures. Herein:

FIG. 1 shows a general layout 1 of a charging system

FIGS. 2a, 2b show a first embodiment of the present invention;

FIGS. 3a, 3b show a second embodiment of the present invention;

FIGS. 4a, 4b show flowcharts of a method according to the invention.

FIG. 1 shows a general layout 1 of a charging system according to the present invention. The system comprises a charger 2 for charging an electric vehicle 3, the charger is operatively coupled to the server farm (cloud) 5. The charger 2 is able to transmit a reference to the mobile device 4, which is then able to access the charge session data stored in the data storage which can be located at the charger, server farm or form a separate entity. Furthermore the cloud 5 can interact through an API with billing and payment applications 7 which run at computers of utilities or other energy providers. A configuration application which is running at the terminal of the charge station operator 6 may also interact with the cloud through an API to configure the charge station. The charger relies for its energy on the power supply 8.

FIG. 2a shows an embodiment of the present invention. A part of a charger 9 for charging the battery of an electric vehicle is shown. The charger comprises a display 10 wherein a reference 11 is shown in the form of a QR code. Furthermore, the display 10 shows a progress-indicator 12 showing the progression of the charge process, and a button 13 to stop the charging process.

An external device embodied by a mobile phone 14 is used to read the reference 11. The reference leads to a server that enables to open a page or download an application that uses information saved by the charger 10.

FIG. 2b shows the mobile phone 14 from FIG. 2a, now displaying the same information as the display of the charger 10 from FIG. 2a does. The mobile phone 14 may be used to monitor the charging process from a distance, and thus to let a user leave the location of the charger.

From this moment the mobile device has started to display the charging process information and the screen at the charger may stop displaying the same information, therefore making it exclusively available for the user of the mobile device while hiding the information for an occasional passer-by or a potential other user of the equipment. In this way the privacy of the first user is guaranteed.

FIG. 3a shows an embodiment of the present invention. The NFC interface 15 of a mobile device is placed in close proximity of the NFC interface 16 of the charger. A communication takes over the NFC channel, wherein the reference is transmitted from the charger to the mobile device and at the same time the user is identified automatically for payment and billing applications.

The reference leads to an application running on the server which enables the user to remotely control and monitor the charging session, as shown in FIG. 3b

FIG. 4a shows a diagram comprising steps [S1-S8] in a method for establishing control over the charger. In the figures, the steps are the following:
[S1] Vehicle connection is detected.
[S2] QR Code is generated.
[S3] The code is scanned by a mobile device.
[S4] The mobile device is linked to the billing and payment application.
[S5] The mobile device is linked to remote monitoring and control application.
[S6] The charging of the vehicle is started by the user.
[S7] The vehicle charging is finished or stopped by the user.
[S8] A bill is applied to the bank account of the user.

FIG. 4b shows another diagram comprising steps [S11-S18] in a method for establishing control over the charger.
[S11] Vehicle connection is detected.
[S12] The NFC tag is reprogrammed with a new code.
[S13] Mobile device with NFC support is held before the NFC tag on the charger, for obtaining the code.
[S14] The user is identified and authorized for remote monitoring and control.
[S15] The mobile device is linked to remote monitoring and control application.
[S16] The charging of the vehicle is started by the user.
[S17] The vehicle charging is finished or stopped by the user
[S18] A payment is deducted from the prepaid account of the user.

It may be also be possible to show advertisement on the screen of the mobile device during the charging.

The above figures are exemplary embodiments only and do not limit the scope of the present invention as defined in the following claims.

1. Charger for charging the battery of an electric vehicle, comprising:
at least one port for exchanging at least one of electric power and data with a vehicle during a charge session;
first data communication means for saving information regarding the charge session to a data storage location;
second data communication means for communicating an optical reference, the second data communications means including a bar or QR code obtaining access to the data storage location, wherein
the first data communication means are configured for saving said information to an external data storage location having a server, and
the second data communication means are configured for communicating a unique reference to the data storage location of said specific charge session.

2. Charger according to claim 1, wherein the reference comprises a hyperlink.

3. Charger according to claim 1, at least partly controllable via the first or second communication means.

4. Charger according to claim 1, comprising the data storage.

5. Charger according to claim 1, comprising means for measuring information regarding the charge session, the means for measuring including a sensor for sensing electric quantities including at least one of current, voltage and power.

6. Charger according to claim 1, comprising a power converter for converting at least one of a power level and waveform from a power source to at least one of a power level and/or and waveform for a vehicle.

7. System for monitoring a charging process, comprising:
a charger according to claim 1, and
an external device configured for receiving and following the reference and for processing the data on the storage location,
wherein the external device includes at least one device selected from the group consisting of a mobile phone, a smart phone, a PDA, a portable computer and a tablet computer.

8. System for monitoring a charging process, comprising:
the charger according to claim 1, wherein the reference leads to a webpage at a server; and
said server, having access to said stored data, and being configured to disclose said data when an external device follows the reference.

9. System according to claim 8, wherein the server is hosting a website that discloses the saved information upon following the reference.

10. System according to claim 8, comprising an external device configured for receiving the reference and for processing the data on the storage location,
wherein the external device includes at least one device selected from the group consisting of a mobile phone, a smart phone, a PDA, a portable computer and a tablet computer.

11. System according to claim 7, wherein the external device is further configured to send a control signal to the first or second communication port of the charger.

12. System according to claim 7, wherein the external device is configured to display a progress of the charge session of a vehicle.

13. System according to claim 7, wherein the external device is configured to display an estimation of the remaining time of the charge session of a vehicle.

14. System according to claim 7, wherein the external device is configured to send a control command to the charger, the control command including at least one of a desired amount of kilometres the vehicle needs to be able to surpass, a maximum payment amount, an available amount of time, and an abort command.

15. System for monitoring a charging process, comprising:
a charger coupled to:
a power supply, for exchanging electric power;
an electric vehicle, for exchanging at least one of electric power and data;
one or more servers coupled to:
said charger, for exchanging data;
an external device, for exchanging data;
said external device coupled to:
said charger, for exchanging data;
said one or more servers, for exchanging data;

16. Communication device, configured for receiving the reference and for processing the data on the storage location, and/or for controlling the charger according to claim 1,
wherein the communication device comprises at least one device selected from the group consisting of a mobile phone, a smart phone, a PDA, a portable computer and a tablet computer.

17. Server comprising an application for configuring a communication device configured for receiving the reference and for processing the data on the storage location, and/or for controlling the charger according to claim 1, for use in a system for monitoring a charging process, the system comprising:
the charger, and
an external device configured for receiving and following the reference and for processing the data on the storage location.

18. Method for monitoring a charge session of an electrical vehicle, the method comprising the steps of:
detecting a connection of the electric vehicle to a port for power exchange of a charger for electric vehicles;
starting a charge session;
saving, by the charger, data regarding the charge session to a data storage location;
providing, by the charger to an external device, a unique reference to the data storage location;
retrieving the stored data and displaying monitoring information based on the data on the external device.

19. Method according to claim 18, comprising:
sending a command from the external device to the charger, for controlling the charge process.

20. Method according to claim 18, comprising:
sending a notification from the charger to the external device, based on an action of a third party at or near the charger.
